(19) United States
(12) Patent Application Publication
(10) Pub. No.: US 2025/0149537 A1
(43) Pub. Date: May 8, 2025

(54) CATHODE MATERIAL PRODUCING METHOD AND CATHODE MATERIAL

(71) Applicant: TOYOTA JIDOSHA KABUSHIKI KAISHA, Toyota-shi (JP)

(72) Inventor: Takahiko NINOMIYA, Miyoshi-shi (JP)

(73) Assignee: TOYOTA JIDOSHA KABUSHIKI KAISHA, Toyota-shi (JP)

(21) Appl. No.: 18/800,431

(22) Filed: Aug. 12, 2024

(30) Foreign Application Priority Data
Nov. 7, 2023 (JP) 2023-190267

(51) Int. Cl. H01M 4/04; H01M 4/02; H01M 4/40

(52) U.S. Cl. CPC H01M 4/0471; H01M 4/405; H01M 2004/028

(57) ABSTRACT

The present disclosure relates to a cathode material producing method and a cathode material. The cathode material producing method includes the following steps: a step of obtaining a mixture including a cathode active material and one kind of lithium alloy; and a step of performing heat treatment for the mixture.

### CROSS-REFERENCE TO RELATED APPLICATION

This application claims priority to Japanese Patent Application No. 2023-190267 filed on Nov. 7, 2023, incorporated herein by reference in its entirety.

### BACKGROUND

### 1. Technical Field

The present disclosure relates to a cathode material producing method and a cathode material.

### 2. Description of Related Art

In a lithium ion secondary battery, part of lithium ions released from a cathode active material during initial charging reacts with an electrolyte on a surface of an anode to form a coating film called solid electrolyte interphase (SEI).

It is desirable that the amount of lithium ions to be consumed along with the formation of SEI be as small as possible because the consumption of lithium ions causes a decrease in the battery capacity. As a measure for suppressing the consumption of lithium ions along with the formation of SEI, it has been proposed that a cathode contains a lithium alloy together with a cathode active material and the amount of lithium ions consumed to form SEI is complemented with lithium ions released from the lithium alloy during initial charging (see, for example, Japanese Unexamined Patent Application Publication (Translation of PCT Application) No. 2021-520614 (JP 2021-520614 A)).

### SUMMARY

The method of containing the lithium alloy in the cathode is effective means for suppressing the initial decrease in the battery capacity. However, metal ions derived from the lithium alloy from which lithium ions have been lost may migrate to the anode side and precipitate. This precipitate may become a resistive layer to cause a decrease in the battery capacity.

An object of the present disclosure is to provide a cathode material producing method and a cathode material that can be used to manufacture a lithium ion secondary battery in which an initial decrease in the battery capacity is suppressed and a decrease in the battery capacity due to repeated charging and discharging is suppressed.

Means for achieving the above object includes the following aspects.
<1> A cathode material producing method including:
obtaining a mixture including a cathode active material and one kind of lithium alloy; and performing heat treatment for the mixture.
<2> The cathode material producing method according to <1>, in which
the lithium alloy is selected from among bismuth, tin, and antimony.
<3> The cathode material producing method according to <1> or <2>, in which
a temperature of the heat treatment is 350° C. or more.
<4> The cathode material producing method according to any one of <1> to <3>, in which
a content of the lithium alloy is 1 part by mass or more and 30 parts by mass or less with respect to 100 parts by mass of the cathode active material.
<5> A cathode material including
a composite including a cathode active material and one kind of lithium alloy.

The embodiment of the present disclosure provides the cathode material producing method and the cathode material that can be used to manufacture the lithium ion secondary battery in which the initial decrease in the battery capacity is suppressed and the decrease in the battery capacity due to repeated charging and discharging is suppressed.

### DETAILED DESCRIPTION OF EMBODIMENTS

In the present disclosure, a numerical range indicated by using “to” means a range including numerical values described before and after “to” as a minimum value and a maximum value, respectively.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.
In the present disclosure, the term “step” is included in the term as long as the intended purpose of the step is achieved, even if it is not clearly distinguishable from other steps as well as independent steps.
In the present disclosure, a combination of two or more preferred embodiments is a more preferred embodiment.
In the present disclosure, the amount of each component means the total amount of a plurality of substances unless otherwise specified, when a plurality of substances corresponding to each component are present.

### Cathode Material Producing Method

A cathode material producing method of the present disclosure includes:
a step of obtaining a mixture including a cathode active material and one kind of lithium alloy; and
a step of performing heat treatment for the mixture.

A secondary battery manufactured using the cathode material manufactured by the method of the present disclosure includes a lithium alloy in a positive electrode. Lithium ions are released from the lithium alloy together with the cathode active material during the first charge of the secondary batteries, thereby complementing the reduction in the amount of lithium ions consumed to form SEI. As a result, a decrease in the initial battery capacity is effectively suppressed.

Further, a secondary battery manufactured using the cathode material manufactured by the method of the present disclosure is less likely to have a lower battery capacity than a secondary battery manufactured using a cathode material that is not manufactured by the method of the present disclosure (specifically, a mixture of a cathode active material and a lithium alloy is not subjected to heat treatment). As a factor of this, it is considered that the solid solution diffusion between the cathode active material and the lithium alloy occurs by the heat treatment of the mixture of the cathode active material and the lithium alloy, and a composite composed of the cathode active material and the lithium alloy is formed. When the lithium alloy is incorporated into the composite, it is considered that the migration of the metal ions derived from the lithium alloy to the negative electrode side is suppressed, and a decrease in the battery capacity is suppressed.

Hereinafter, a step of obtaining a mixture containing a cathode active material and one type of lithium alloy is also referred to as a first step, and a step of heat-treating the mixture is also referred to as a second step.

### First Step

In the first step, a mixture containing a cathode active material and one type of lithium alloy is obtained.

The lithium alloy used in the first step preferably contains a metal element with an alloying potential with lithium of 0.5 V (vs. Li/Li⁺) or more.
When the metal element contained in the lithium alloy has the alloying potential described above, the reduction in the amount of lithium ions released from the cathode active material and consumed to form SEI during the first charge of the batteries is effectively compensated. As a result, a decrease in the initial battery capacity is effectively suppressed.

Examples of the metal elements with an alloying potential with lithium of 0.5 V (vs. Li/Li⁺) or more include bismuth (Bi, alloying potential: 0.81 V to 0.83 V), tin (Sn, alloying potential: 0.57 V to 0.66 V) and antimony (Sb, alloying potential: 0.94 V to 0.96 V).

That is, the lithium alloy included in the cathode material includes a lithium alloy containing bismuth (hereinafter, also referred to as a Li—Bi alloy), a lithium alloy containing tin (hereinafter, also referred to as a Li—Sn alloy), and a lithium alloy containing antimony (hereinafter, also referred to as a Li—Sb alloy).

Specific examples of Li—Bi include Li₃Bi.

Specific examples of Li—Sb include Li₃Sb.
Specific examples of Li—Sn include LiSn.
From the viewpoint of suppressing a decrease in the battery capacity due to repetition of charging and discharging, the lithium alloy contained in the cathode material is preferably a Li—Bi alloy.

The cathode material comprises one type of lithium alloy. In the present disclosure, the cathode material “including one type of lithium alloy” means that only one type of the metal element having the highest content is included among the metal elements other than lithium constituting the lithium alloy included in the cathode material.

From the viewpoint of sufficiently complementing the consumption of lithium ions accompanying the formation of SEI, the content of the lithium alloy contained in the cathode material is preferably 1 part by mass or more, more preferably 2 parts by mass or more, and still more preferably 5 parts by mass or more with respect to 100 parts by mass of the cathode active material.

From the viewpoint of ensuring sufficient energy density, the content of the lithium alloy contained in the cathode material is preferably 30 parts by mass or less, more preferably 20 parts by mass or less, and still more preferably 15 parts by mass or less with respect to 100 parts by mass of the cathode active material.

The lithium alloy may be in particulate form. The volume average particle diameter of the lithium alloy in a particulate form is not particularly limited, and can be selected from, for example, a range of 1 μm to 50 μm.

The volume-average particle size of the particles is a D50 when the cumulative volume is 50% in the volume-based particle size distribution measured by the laser diffractometry and scattering method.

Examples of the cathode active material used in the first step include a composite oxide of lithium and a transition metal (hereinafter, also referred to as a lithium transition metal composite oxide).

Examples of the lithium transition metal composite oxide include a layered lithium transition metal composite oxide, a spinel-type lithium transition metal composite oxide, and an olivine-type lithium transition metal composite oxide.
Specific examples of the layered lithium transition metal complex oxide include a compound represented by LiMO₂ (M is at least one transition metal selected from the group consisting of Ni, Co, and Mn), and a compound in which a hetero element is added to the compound. Examples of the dissimilar element include Al, Mg, La, Ti, Zn, B, W, Fe, Cr, V, Ru, Cu, Cd, Ag, Y, Sc, Ga, In, As, Sb, Pt, Au, Si, and the like.
Specific examples of the spinel-type lithium-transition-metal complex oxide include LiMn₂O₄.
Specific examples of the olivine-type lithium-transition-metal complex oxide include LiMPO₄ (M is Fe, Co, Ni, or Mn).
The cathode active material contained in the cathode material may be one kind alone or two or more kinds thereof.

Among the lithium transition metal composite oxides, a layered lithium transition metal composite oxide containing at least one selected from Ni, Co, and Mn as a transition metal is more preferable. Further preferred is a layered lithium transition metal complex oxide comprising Ni as transition metal and at least one selected from Co and Mn. Further preferred is a layered lithium transition metal complex oxide (NCM, nickel cobalt manganese oxide) containing Ni, Co, and Mn as transition metals, respectively.

The molar ratio of Ni, Co, and Mn in NCM may be selected, for example, from the range of a molar ratio (Ni:Co) of Ni to Co of 1:0.1 to 1:1, and the molar ratio (Ni:Mn) of Ni to Mn of 1:0.1 to 1:1.

The molar ratio of Ni to Co (Ni:Co) may be selected from 1:0.1 to 1:0.5, 1:0.1 to 1:0.3, or 1:0.1 to 1:0.2.

The molar ratio of Ni to Mn (Ni:Mn) may be selected from 1:0.1 to 1:0.5, 1:0.1 to 1:0.3, or 1:0.1 to 1:0.2.

The cathode active material may be in particulate form.

The volume average particle diameter of the cathode active material in a particulate form is not particularly limited, and can be selected from, for example, a range of 5 μm to 30 μm. When the cathode active material is a secondary particle that is an aggregate of a plurality of primary particles, the volume average particle diameter is the volume average particle diameter of the secondary particles.

A method for obtaining a mixture containing a cathode active material and one type of lithium alloy in the first step is not particularly limited, and a conventional method can be employed.

### Second Step

In the second step, heat treatment is performed on the mixture containing the cathode active material obtained in the first step and one type of lithium alloy.

As shown in Examples to be described later, a battery manufactured using a cathode material obtained by performing a heat treatment of a mixture of a cathode active material and a lithium alloy has a better battery capacity than a battery manufactured using a cathode material obtained without performing a heat treatment of the mixture. As a factor of this, it is considered that the solid solution diffusion between the cathode active material and the lithium alloy occurs by the heat treatment of the mixture, and a composite composed of the cathode active material and the lithium alloy is formed. When the lithium alloy is incorporated into the composite, it is considered that the migration of the metal ions derived from the lithium alloy to the negative electrode side is effectively suppressed.

The temperature of the heat treatment is preferably 350° C. or higher, and may be 450° C. or higher, 550° C. or higher, or 650° C. or higher.

The temperature of the heat treatment may be 1000° C. or less, 900° C. or less, or 800° C. or less.
The time period of the heat treatment is not particularly limited, and may be selected from the time period of 30 minutes to 5 hours.
The heat treatment is preferably performed in an inert atmosphere such as nitrogen or argon.

The mixture after the heat treatment is preferably in a state in which at least a part of the cathode active material and at least a part of the lithium alloy form a composite (solid solution or the like).

The mixture after the heat treatment may be subjected to a crushing treatment to form particles.

The volume-average particle size of the particles obtained by crushing the mixture after the heat treatment can be selected, for example, from the range of 5 μm to 30 μm.

### Cathode Material

The cathode material of the present disclosure includes a composite composed of a cathode active material and one type of lithium alloy.

Details and preferred aspects of the cathode active material and the lithium alloy included in the cathode material are the same as the details and preferred aspects of the cathode active material and the lithium alloy used in the cathode material producing method described above.

The composite composed of the cathode active material and one type of lithium alloy contained in the cathode material may be in a state in which solid solution diffusion between the cathode active material and the lithium alloy occurs by heat treatment of the mixture of the cathode active material and the lithium alloy.

The composite composed of the cathode active material and one type of lithium alloy contained in the cathode material may be in a particulate form.
The volume-average particle size of the particles obtained by crushing the mixture after the heat treatment can be selected, for example, from the range of 5 μm to 30 μm.

The cathode material of the present disclosure may further include other components used as the material of the positive electrode of the lithium ion secondary battery. For example, the cathode material may be in a state of a mixture containing components other than the cathode active material and the lithium alloy, such as a conductive auxiliary agent and a binder. If desired, a solvent may be added to the mixture to adjust the viscosity of the mixture.

Specific examples of the conductive aid include carbon materials such as carbon black (acetylene black, thermal black, furnace black, and the like), carbon nanotubes, and graphite.

The conductive material contained in the cathode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate.

The binder contained in the cathode material may be one kind alone or two or more kinds thereof.

The cathode material of the present disclosure is used as a material of a positive electrode of a lithium ion secondary battery. The positive electrode includes, for example, a current collector and a positive electrode layer disposed on the current collector, and the positive electrode layer includes the cathode material of the present disclosure. The positive electrode layer may be disposed on one side or both sides of the current collector.

Examples of the material constituting the current collector of the positive electrode include aluminum, an aluminum alloy, nickel, titanium, and stainless steel. Examples of the shape of the current collector include a foil and a mesh.

The positive electrode layer is disposed on the current collector by, for example, applying a slurry-like cathode material to one or both surfaces of the current collector. If necessary, a pressure treatment for adjusting the density of the positive electrode layer may be performed. The thickness of the positive electrode layer is not particularly limited, and can be selected from, for example, a range of 10 μm to 100 μm.

The lithium ion secondary battery obtained using the cathode material of the present disclosure includes, for example, a positive electrode, a negative electrode, a separator disposed between the positive electrode and the negative electrode, and an electrolyte.

The negative electrode includes, for example, a current collector and a negative electrode layer disposed on the current collector and including a negative electrode active material. Examples of the negative electrode active material include carbon materials such as graphite, hard carbon, soft carbon, and activated carbon, silicon, metallic lithium, lithium alloy, and lithium titanate (LTO).
Examples of the material constituting the current collector of the negative electrode include copper, a copper alloy, nickel, titanium, and stainless steel. Examples of the shape of the current collector of the negative electrode include a foil and a mesh.
Examples of the separator include a nonwoven fabric, a cloth, and a microporous film containing a polyolefin as a main component, such as polyethylene and polypropylene. The electrolyte may be either a liquid or a solid. As the liquid electrolyte (electrolyte solution), a solution obtained by dissolving a known electrolyte such as LiPF₆ in an organic solvent can be used without any particular limitation. As the solid electrolyte, a known solid electrolyte such as a sulfide solid electrolyte, an oxide solid electrolyte, or a halide solid electrolyte can be used without any particular limitation.

Hereinafter, the present disclosure will be described in more detail with reference to Examples, but the disclosure of the present disclosure is not limited to these Examples.

### Preparation of Evaluation Battery

NCM (LiNi_{0.8}Co_{0.1}Mn_{0.1}O₂) as a cathode active material and LiB₃, Li₃Sb and LiSn as lithium alloy in the amounts shown in Table 1 were used in the preparation of the batteries of the respective Examples.

The amount of each component was adjusted so that the total volume of the cathode active material and the lithium alloy was equal in each example.

In Examples 1 to 3, the mixture of the cathode active material and the lithium alloy shown in Table 1 was subjected to a heat treatment in a nitrogen atmosphere at 700° C. for 2 hours, and then subjected to a crushing treatment to obtain composite particles of the cathode active material and the lithium alloy.

In Comparative Examples 1 to 5, heat treatment was not performed on the mixture of the cathode active material and the lithium alloy shown in Table 1.

A slurry-like cathode material was obtained by mixing a mixture (93 g) of a cathode active material and a lithium alloy, carbon black (4 g) as a conductive auxiliary agent, PVDF (3 g) as a binder, and a solvent (NMP).

The obtained cathode material was coated on an aluminum foil and dried to obtain a positive electrode. The obtained positive electrode, separator (polyethylene microporous film), and negative electrode containing graphite as an active material are laminated in this order to prepare an electrode body. This electrode assembly and an electrolyte solution (a mixed solvent of ethylene carbonate/dimethyl carbonate/ethyl methyl carbonate containing LiPF₆ as an electrolyte) were used to prepare a laminate-type cell for evaluating.

### Evaluation of Battery Performance

210 mA/g current was defined as 1 C rate based on the mass of the cathode active material contained in the cell, and CCCV charge and CCCV discharge were performed under the following conditions. The obtained CCCV capacity was defined as the capacity of the cell (initial discharging capacity).
Lower limit: 2.5 V
Upper limit: 4.25 V
Charge/discharge current: 0.2 C
Termination current: 0.03 C
   Thereafter, cycling tests (CC charge and CC discharging) of the batteries were performed. Table 1 shows the number of cycles when CC discharge capacity of the batteries reaches 40% or less of the initial discharge capacity.
   As the number of cycles shown in Table 1 increases, it can be determined that a decrease in battery capacity due to repetition of charging and discharging is further suppressed.

TABLE 1

| | Cathode active | | | | | | | | | |
|---|---|---|---|---|---|---|---|---|---|---|
| | material | | Li alloy 1 | | | Li alloy 2 | | | Total | |
| | Mass | Volume | Alloy | Mass | Volume | Alloy | Mass | Volume | Volume | Number |
| | [mg] | [cm³] | type | [mg] | [cm³] | type | [mg] | [cm³] | [cm³] | of cycles |
| Example 1 | 92.3 | 0.0200 | Li₃Bi | 8.4 | 0.0017 | — | — | — | 0.0217 | 61 |
| Example 2 | 92.8 | 0.0202 | Li₃Sb | 5.2 | 0.0015 | — | — | — | 0.0217 | 59 |
| Example 3 | 87.3 | 0.0190 | LiSn | 13.8 | 0.0027 | — | — | — | 0.0217 | 54 |
| Comparative | 92.3 | 0.0200 | Li₃Bi | 8.4 | 0.0017 | — | — | — | 0.0217 | 26 |
| Example 1 | | | | | | | | | | |
| Comparative | 92.8 | 0.0202 | Li₃Sb | 5.2 | 0.0015 | — | — | — | 0.0217 | 26 |
| Example 2 | | | | | | | | | | |
| Comparative | 87.3 | 0.0190 | LiSn | 13.8 | 0.0027 | — | — | — | 0.0217 | 24 |
| Example 3 | | | | | | | | | | |
| Comparative | 92.6 | 0.0201 | Li₃Bi | 4.2 | 0.00085 | Li₃Sb | 2.6 | 0.00075 | 0.0217 | 41 |
| Example 4 | | | | | | | | | | |
| Comparative | 89.9 | 0.0195 | Li₃Bi | 4.2 | 0.00085 | LiSn | 6.9 | 0.00135 | 0.0217 | 42 |
| Example 5 | | | | | | | | | | |

As shown in Table 1, the batteries of Examples 1 to 3 in which the heat treatment was performed on the mixture of the cathode active material and the lithium alloy exhibited an excellent capacity retention ratio as compared with the batteries of Comparative Examples 1 to 5 in which the heat treatment was not performed on the mixture of the cathode active material and the lithium alloy.

Evaluation of Metal Ion Release from Lithium Alloys

The cell after the cycle test was disassembled, and the positive electrode was taken out. Sample solutions were prepared from the positive electrode layers using an acid. Elemental analysis was performed by Inductively coupled plasma atomic emission spectroscopy (ICP-AES).

The concentration of the metal element in the lithium alloy used in the preparation of the positive electrode is shown in Table 2 as a ratio when the initial concentration is 100.

TABLE 2

| | Li alloy 1 | | Li alloy 2 | |
|---|---|---|---|---|
| | Element | Residual rate | Element | Residual rate |
| Example 1 | Bi | 83 | — | — |
| Example 2 | Bi | 84 | — | — |
| Example 3 | Sb | 81 | — | — |
| Comparative | Bi | 46 | — | — |
| Example 1 | | | | |
| Comparative | Sb | 38 | — | — |
| Example 2 | | | | |
| Comparative | Sn | 32 | — | — |
| Example 3 | | | | |
| Comparative | Bi | 45 | Sb | 40 |
| Example 4 | | | | |
| Comparative | Bi | 48 | Sn | 35 |
| Example 5 | | | | |

As shown in Table 2, in the batteries of Examples 1 to 3 in which the heat treatment was performed on the mixture of the cathode active material and the lithium alloy, the residual rate of the metal element derived from the lithium alloy in the positive electrode was higher than that of the batteries of Comparative Examples 1 to 5 in which the heat treatment was not performed on the mixture of the cathode active material and the lithium alloy.

The above results suggest that the transfer of the metal element derived from the lithium alloy to the negative electrode side is effectively suppressed by performing the heat treatment on the mixture of the cathode active material and the lithium alloy.

What is claimed is:

1. A cathode material producing method comprising:
obtaining a mixture including a cathode active material and one kind of lithium alloy; and
performing heat treatment for the mixture.

2. The cathode material producing method according to claim 1, wherein the lithium alloy is selected from among bismuth, tin, and antimony.

3. The cathode material producing method according to claim 1, wherein a temperature of the heat treatment is 350° C. or more.

4. The cathode material producing method according to claim 1, wherein a content of the lithium alloy is 1 part by mass or more and 30 parts by mass or less with respect to 100 parts by mass of the cathode active material.

5. A cathode material comprising a composite including a cathode active material and one kind of lithium alloy.
